(19) United States
(12) Patent Application Publication
(10) Pub. No.: US 2026/0297473 A1
(43) Pub. Date: Oct. 1, 2026

(54) DISINFECTANT COMPOSITION

(71) Applicant: GAMA HEALTHCARE LTD, Hemel Hempstead (GB)

(72) Inventor: Leah CONWAY, Hemel Hempstead (GB)

(73) Assignee: GAMA HEAL THCARE LTD, Hemel Hempstead (CH)

(21) Appl. No.: 19/679,365

(22) Filed: May 15, 2026

Related U.S. Application Data
(63) Continuation of application No. PCT/EP2024/054533, filed on Feb. 22, 2024.

(30) Foreign Application Priority Data
Nov. 16, 2023 (GB) 2317589.6

(51) Int. Cl. C11D 17/04; C11D 1/14; C11D 3/20; C11D 3/32; C11D 3/36; C11D 3/39; C11D 17/00

(52) U.S. Cl. CPC C11D 17/044; C11D 1/146; C11D 3/2086; C11D 3/32; C11D 3/361; C11D 3/3942; C11D 17/0039; C11D 2111/14

(57) ABSTRACT

The disclosure is concerned with a solid composition, comprising 40 to 60% by weight of a peroxygen donor, 20 to 35% by weight of an acetyl donor, 10 to 35% by weight of a coated organic acid, and 0.1 to 1.5% by weight of glycolic acid or lactic acid.

The solid composition is suitable as a cleaning agent and disinfectant, in particular for hard surfaces, wherein, before use, the solid composition is dissolved in water to obtain an aqueous solution.

### CROSS-REFERENCE TO RELATED APPLICATIONS

The present application is a continuation application claiming priority from international application PCT/EP2024/054533, filed Feb. 22, 2024, which claims priority from Great Britain Application No. 2317589.6, filed Nov. 16, 2023, both of which are incorporated herein in their entireties.

### FIELD OF THE DISCLOSURE

The present disclosure relates to a solid composition comprising a peroxygen donor and an acetyl donor suitable as a cleaning agent and disinfectant, in particular for inanimate surfaces, a unit dosage package comprising the solid composition and the use of the solid composition.

### DESCRIPTION OF THE RELATED ART

Disinfectant compositions such as floor cleaner products based on peracetic acid are known in the prior art. These compositions generally include a peroxygen donor such as sodium percarbonate (SP) and an acetyl donor such as tetraacetylethylenediamine (TAED) as precursors to generate peracetic acid (PAA) and hydrogen peroxide in situ. The disinfectant compositions are usually in form of a powder or granules and packaged in a package such as a sachet.

The disinfectant compositions of the prior art usually require the use of a mixing bottle/vessel to aid in mixing and dissolution of the precursors in water. Other chemistries with the intended application of hard surface cleaning and disinfection focus on chlorine as the active. Chlorine based products can be chlorine only or combined with a detergent to provide cleaning and disinfecting activity.

Chlorine is currently the main disinfectant used for cleaning in hospitals. Chlorine has poor efficacy in soiled conditions (in the presence of organic material). This impacts its efficacy against hard to kill microbes such as bacterial spores. For routine and terminal cleaning chlorine is frequently applied with absorbent cotton cloths or microfibre cloths. The non-woven in these material substrates can further impact the efficacy of chlorine.

The object of the present disclosure is to overcome the problems of the prior art cited above. In particular, the object of the disclosure is to provide a composition suitable for cleaning and disinfectant purposes, in particular for hard surfaces, which provides stable and consistent delivery of peracetic acid for the required duration of the cleaning process when dissolved in water. Specifically, the composition should be suitable for use without the need of a special mixing device and should be dissolvable as far as possible in order to avoid solid residues after application.

In addition, the composition suitable for cleaning and disinfectant purposes should also be compatible with a range of hard surfaces and enable application in conjunction with different non-woven fabrics without compromising efficacy.

### SUMMARY OF THE DISCLOSURE

The inventors have surprisingly found that the object can be achieved by a specific solid composition as outlined below.

Accordingly, the present disclosure is directed to a solid composition, comprising:
40 to 60% by weight, preferably 40 to 55% by weight, of a peroxygen donor,
20 to 35% by weight, preferably 20 to 28% by weight, of an acetyl donor, preferably in powder form,
10 to 35% by weight, preferably 20 to 30% by weight, of a coated organic acid, wherein the organic acid is preferably citric acid, malic acid or tartaric acid, more preferably citric acid, and
optionally 0.1 to 1.5% by weight, preferably 0.3 to 1% by weight, of glycolic acid or lactic acid.

Optionally the composition further comprising a further organic acid, optionally wherein by weight the combination of the coated organic acid and the further organic acid is 15 to 35%.

Optionally wherein the further organic acid comprises 2 to 10% by weight, preferably 3 to 9% by weight, more preferably 4 to 8% by weight, most preferably 4 to 6% by weight.

The solid composition of the disclosure provides stable and consistent delivery of PAA for the required duration of the cleaning process, when it is dissolved in water. The coated organic acid, preferably coated citric acid, supports sustained PAA generation over time by buffering the pH in the range of 3 to 10, preferably 6 to 8, and more preferably 6.5 to 7.5.

The PAA generated provides broad spectrum activity also in the presence of organic material. Peracetic acid breaks down to food-safe and environmentally friendly residues (acetic acid, water and oxygen).

The solid composition of the disclosure is compatible with a wide range of hard surfaces. No cracking is observed during repeated application. The use in conjunction with different non-woven fabrics is possible without compromising efficacy.

When the solid composition is added to water to obtain an aqueous solution, a swift dissolution of the solid composition takes place. No specific mixing devices are required. The solid composition dissolves completely or almost completely in water or aqueous solution. Hence, the amount of residue remaining on surfaces after application of the solid composition dissolved in water or aqueous solution is low or even absent. The optional presence of one or more surfactants in the formulation aid in cleaning and optimises reduction of residue/streaking.

As a result, the challenge of generating sustained release of PAA, dissolution in water with low residue, and with the correct microbial efficacy and material compatibility profile has been achieved by the solid composition of the disclosure. As opposed to cleaning compositions based on chlorine, the presence of soil does not significantly reduce the efficacy.

A particular benefit of the solid composition of the disclosure is that a suitable PAA concentration, e.g. for hospital applications, can already be reached within 15 minutes after addition of the solid composition with water. Moreover, a rather constant PAA concentration is achieved for a long period.

It has been found that use of the coated organic acid alone is effective—but that when the solid composition is packaged in a coating such as a water soluble sachet, and the coating and composition are applied to water the appearance of the composition in the water can be unappealing. In particular, the mixture can resemble a “snow globe” in which there is floating debris. The use of a further organic acid in combination with the coated organic acid has been found to reduce this effect and make the appearance of the mixture more appealing.

### BRIEF DESCRIPTION OF THE DRAWINGS

Embodiments of the present disclosure are described herein with reference to the following figures.

FIG. 1 is a plot of total PPA for powder vs. granule in Example 2.

FIG. 2 is a plot of total PPA for various levels of coated citric acid in Example 2.

FIG. 3 is a plot of total PPA for various levels of glycolic acid in Example 3.

FIG. 4 is a plot of active PPA for various levels of various coated acids in Example 4.

FIG. 5 is a plot of active PPA for sodium bicarbonate addition for various coated acids in Example 6.

FIG. 6 is a plot of active PPA for water temperature variation for various coated acids in Example 7.

FIGS. 7, 8, and 9 are plots of active PPA for water temperature variation for different solid composition amounts in Example 8.

FIGS. 10, 11, 12, and 13 are plots of active PPA for different quantities of 20% coated citric acid in Example 9.

FIGS. 14, 15, and 16 are plots of active PPA for various amounts of coated citric acid vs. time in Example 12.

FIG. 17 is a plot of active PPA for coated citric acid vs. anhydrous tartaric acid in comparative test data in Example 12.

FIG. 18 is a plot of active PPA for coated citric acid vs. anhydrous citric acid in comparative test data in Example 12.

### DETAILED DESCRIPTION OF THE DISCLOSURE

In the following, the disclosure is described in detail.

The weight proportions given for the components of the solid composition of the disclosure are based on the total weight of the solid composition.

### Peroxygen Donor

The solid composition of the disclosure comprises 40 to 60% by weight, preferably 40 to 55% by weight, more preferably 40 to 50% by weight, of a peroxygen donor. The peroxygen donor is preferably in form of a powder or granules.

Any compound known to be suitable as peroxygen donor or a mixture thereof can be used. The peroxygen donor can be e.g. selected from sodium perborate, ammonium perborate, sodium percarbonate, potassium percarbonate, ammonium percarbonate, sodium perphosphate, ammonium persulphate, urea peroxide, peresters, superoxides, dioxygenyl, ozones, hydrogen peroxide, lithium peroxide, barium peroxide, di-tert-butyl peroxide, ammonium peroxydisulphate and potassium peroxymonosulphate or any mixture thereof.

The peroxygen donor is preferably selected from sodium perborate, sodium percarbonate, sodium perphosphate, urea peroxide, peresters, superoxides, dioxygenyl, ozones, lithium peroxide, barium peroxide, di-tert-butyl peroxide, ammonium peroxydisulphate, potassium peroxymonosulphate or any mixture thereof.

The most preferable peroxygen donor is sodium percarbonate (SP), preferably in form of a powder or granules.

### Acetyl Donor

The solid composition of the disclosure comprises 20 to 35% by weight, preferably 20 to 28% by weight, of an acetyl donor. The acetyl donor is in one embodiment in the form of a powder or granules, such as in the form of a powder.

As the acetyl donor, any compound known to be suitable as acetyl donor or a mixture thereof can be used. For instance, the acetyl donor can be selected from tetraacetylethylenediamine (TAED), methyl cellulose encapsulated TAED, acetyl salicylic acid, diacetyl dioxohexahydratriazine (DADHT), tetraacetyl glycoluril, acetyl urea, di-acetyl urea, tri-acetyl urea, pentaacetyl glucose (PAG), tetraacetyl glycoluril (TAGU), acetyl phosphate, acetyl imidazole, acetyl CoA, acetic anhydride, compounds containing a hemiacetal group, acetic acid, di-acetylmorphine, pyruvate, acetyl chloride, acetyl-caprolactam, N′N′-diacetyl-N′N′-dimethyl urea or any mixture thereof.

The acetyl donor is most preferably tetraacetylethylenediamine (TAED), such as in the form of a powder or granules, such as in the form of a powder.

The weight ratio of the peroxygen donor to the acetyl donor in the solid composition is preferably in the range from 3:1 to 1.2:1, more preferably 2.5:1 to 1.5:1. A particular suitable weight ratio of the peroxygen donor to the acetyl donor is about 2:1.

### Coated Organic Acid

The solid composition of the disclosure comprises 15 to 35% by weight, preferably 20 to 30% by weight, of a coated organic acid. The coated organic acids are commercially available and often used in food industry.

The coated organic acid, preferably coated citric acid, is used to modify the pH for optimum PAA generation as well as suitable active PAA concentrations. The coated organic acid, preferably coated citric acid, supports sustained PAA generation over time as compared to use of uncoated organic acid.

The organic acid is generally a solid organic acid. The organic acid may comprise one, two three or more carboxylic groups, preferably two, three or more carboxylic groups.

Suitable examples for the organic acid are citric acid, fatty acids, sorbic acid, malic acid, tartaric acid, glutaric acid or any mixtures thereof. The organic acid is preferably citric acid, malic acid or tartaric acid. The organic acid is most preferably citric acid.

The organic acid is generally in particulate form such as a powder or granules. The organic acid or the particles of the organic acid, respectively, is provided with a coating to form the coated organic acid. The coated organic acid may be in form of core shell particles.

The coating of the coated organic acid is preferably selected from oils, fats or mixtures thereof, preferably a vegetable oil or fat or an animal oil or fat, more preferably a vegetable oil. The coating of the coated organic acid is more preferably a vegetable oil or an animal fat, more preferably a vegetable oil. Suitable examples for vegetable oils are palm oil, coconut, shea, rapeseed oil, and glyceryl monostearate.

The content of the organic acid in the coated organic acid is preferably in the range of 30 to 96% by weight, preferably 50 to 93% by weight, based on the total weight of the coated organic acid. The balance is generally provided by the coating. In a preferred embodiment, content of the organic acid in the coated organic acid is in the range of 55 to 90% by weight.

The coated organic acid such as coated citric acid is usually in form of a powder or granules. In a preferred embodiment, the coated organic acid such as coated citric acid is in granular form. The granule size of the coated organic acid such as coated citric acid is preferably less than 5000 micron, more preferably less than 3000 micron, still more preferably less than 2500 micron, wherein the granule size is the d₉₉ value determined by sieve analysis. A d₉₉ value of 2000 micron determined by sieve analysis means that at least 99% by weight of the sample pass through a 2000 micron sieve.

### Glycolic Acid (Co-Active Agent)

The solid composition of the disclosure comprises 0.1 to 1.5% by weight, preferably 0.3 to 1% by weight, glycolic acid. An alternative acid that may be used is lactic acid. We note that any alternative acid that achieves substantially the same result in substantially the same way (i.e. an acid present in a crystalline or powdered form that acts as a co-active agent in the same manner) may be used. Strict compliance with glycolic acid, or lactic acid is not envisaged.

The glycolic acid acts as a co-active agent and supports the generation of PAA based on the precursors, i.e. the peroxygen donor such as SP and the acetyl donor such as TAED.

### Chelating Agent (Optional Component)

The solid composition of the disclosure may further comprise one or more chelating agents, preferably in amounts of 0.2 to 2% by weight, more preferably 0.3 to 1.5% by weight.

The addition of a chelating agent is beneficial if metal ions such as e.g. sodium, potassium, magnesium, calcium and/or iron ions, are present in the water that is added to the solid composition to prepare the aqueous solution of the solid composition. This is because chelating agents can mask metal ions which may be present in the water added. Such metal ions significantly affect the reaction of the peroxygen donor and the acetyl donor.

With respect to the chelating agent, any chelating agent known to be suitable for masking (chelating) metal ions can be used. Examples for the chelating agent are ethylenediaminetetraacetic acid (EDTA), ethylenebis(oxyethylenenitrilo)tetraacetic acid, diethylenetriaminepentaacetic acid (DTPA), and 1-hydroxy ethylidene-1,1-diphosphonic acid (HEDP).

In a preferred embodiment, the one or more chelating agents comprise or is 1-hydroxyethylidene-1,1-diphosphonic acid (HEDP).

### Surfactant (Optional Component)

The solid composition of the disclosure may further comprise one or more surfactants, preferably in an amount of 0.5 to 8% by weight, more preferably 1 to 5% by weight.

The optional presence of one or more surfactants in the formulation aids in cleaning and optimises reduction of residue/streaking.

The one or more surfactants may be selected from cationic, anionic, amphoteric or non-ionic surfactants or mixtures thereof. The one or more surfactants are preferably selected from anionic surfactants and/or nonionic surfactants, wherein anionic surfactants are most preferred. Examples of anionic surfactants are alkylsulphates such as ammonium lauryl sulphate and sodium lauryl sulphate (SLS), and alkyl-ether sulphates such as sodium laureth sulfate (SLES), and sodium myreth sulphate. Examples of nonionic surfactants are fatty alcohol ethoxylates, alkyl phenol ethoxylates and fatty acid alkoxylates.

In a preferred embodiment, the one or more surfactants are anionic surfactants. It is preferred that the one or more surfactants comprises or is sodium lauryl sulfate (SLS).

### Further Optional Additives

The solid composition of the disclosure may comprise one or more additives, which are common in this technical field. The one or more additives may be selected e.g. from dyes, preservatives, bases, essential oils or fragrances.

The base may be used to adjust the pH of the aqueous solution according to the needs. Examples of a suitable base are sodium bicarbonate, sodium hydroxide, potassium hydroxide, calcium hydroxide, and calcium carbonate.

### Preferred Embodiments of the Solid Composition

The solid composition comprises

40 to 60% by weight, preferably 40 to 55% by weight, more preferably 40 to 50% by weight, of a peroxygen donor, wherein the peroxygen donor is preferably sodium percarbonate (SP), such as in form of a powder or granules, 20 to 35% by weight, preferably 20 to 28% by weight, of an acetyl donor, preferably in powder or granule form, wherein the acetyl donor is preferably tetraacetylethylenediamine (TAED),

10 to 35% by weight, preferably 20 to 30% by weight, of a coated organic acid, wherein the organic acid is preferably citric acid, malic acid or tartaric acid, more preferably citric acid, wherein the content of the organic acid in the coated organic acid is preferably 30 to 96% by weight, preferably 50 to 93% by weight, more preferably 55 to 90% by weight, based on the total weight of the coated organic acid, and

optionally 0.1 to 1.5% by weight, preferably 0.3 to 1% by weight, of glycolic acid or lactic.

In a preferred embodiment, the solid composition further comprises one or more chelating agents and/or one or more surfactants, preferably one or more chelating agents and one or more surfactants. The chelating agent is preferably contained in an amount of 0.2 to 2% by weight, preferably 0.3 to 1.5% by weight. The chelating agent is preferably 1-hydroxyethylidene-1,1-diphosphonic acid (HEDP). The surfactant is preferably contained in an amount of 0.5 to 8% by weight, more preferably 1 to 5% by weight. The surfactant is preferably an anionic surfactant, more preferably sodium lauryl sulfate (SLS).

Accordingly, a particular preferred embodiment of the solid composition comprises
40 to 60% by weight, preferably 40 to 55% by weight, more preferably 40 to 50% by weight, of a peroxygen donor, wherein the peroxygen donor is preferably sodium percarbonate (SP), such as in form of a powder or granules,
20 to 35% by weight, preferably 20 to 28% by weight, of an acetyl donor, preferably in powder or granule form, wherein the acetyl donor is preferably tetraacetylethylenediamine (TAED),
15 to 35% by weight, preferably 20 to 30% by weight, of a coated organic acid, wherein the organic acid is preferably citric acid, malic acid or tartaric acid, more preferably citric acid, wherein the content of the organic acid in the coated organic acid is preferably 30 to 96% by weight, preferably 50 to 93% by weight, more preferably 55 to 90% by weight, based on the total weight of the coated organic acid, 0.1 to 1.5% by weight, preferably 0.3 to 1% by weight, of glycolic acid,
0.2 to 2% by weight, preferably 0.3 to 1.5% by weight, of one or more chelating agents, which comprise or is preferably 1-hydroxyethylidene-1,1-diphosphonic acid (HEDP), and
0.5 to 8% by weight, preferably 1 to 5% by weight, of one or more surfactants, preferably anionic surfactants, which preferably comprise or is sodium lauryl sulfate (SLS).

### Use of Solid Composition in Water and Generation of Peracetic Acid

In use, the solid composition of the disclosure is added to water to obtain an aqueous solution thereof. It may be suitable to stir the aqueous solution for some time to support dissolution, preferably manually, e.g. with a stirring rod or mixing paddle, but this is usually not necessary. In particular, mixing devices with electrically driven mixing means are usually not necessary, but of course can be used, if desired.

The water to which the solid composition is added may be e.g. tap water, council water or domestic water. The water may comprise one or more additives.

The concentration of the solid composition in the water may vary in wide ranges. Suitable concentrations of the solid composition in the water or aqueous solution may be for instance 1 g to 90 g solid composition per litre water, preferably 5 g to 20 g solid composition per litre water, more preferably 8 g to 19 g, and most preferably 8 g to 10 g solid composition per litre water.

The water to which the solid composition is added may be cold water or warm water, e.g. water having a temperature in the range of 10 to 55° C., preferably 30 to 45° C.

The aqueous solution prepared by the addition of the solid composition to water may have a pH value in the range of 5.0 to 9.5, preferably 6.0 to 9.0, more preferably 6.0 to 8.0.

When water is added to the solid composition, the peroxygen donor is capable of forming hydrogen peroxide in the aqueous solution obtained. The acetyl donor is capable to react with the hydrogen peroxide generated to produce a mixture of peracetic acid and hydrogen peroxide.

Glycolic acid acts as a co-active agent and supports PAA generation by the peroxygen donor and the acetyl donor.

### Form of Solid Composition and Unit Dosage Package

The solid composition of the disclosure is preferably in form of powder, granules, or a mixture of powder and granules. The powder is preferably crystalline powder. The granules are preferably made of crystalline powder. The solid composition can be also in a compacted form such as tablets or capsules. In the compacted form, the solid composition, generally in form of powder, granules, or a mixture of powder and granules, is compacted to a suitable form, such as tablets or capsules, e.g. in a moulding press or tabletting machine.

The solid composition of the disclosure, in particular in one of the forms discussed above, is usually packaged in a package such as a container, a sachet or a pod, wherein the package is preferably a water-soluble package. In a preferred embodiment, the solid composition of the disclosure, in particular in one of the forms discussed above, is packaged in a sachet or pod, preferably a water-soluble sachet or water-soluble pod. The solid composition will be most preferably packaged into a water dissolvable film, similar to those packages used for dishwasher tablets/capsules.

Water-soluble packages such as water-soluble sachets or water-soluble pods are usually made of water-soluble films, in particular water-soluble plastic films. Water-soluble films for packaging are known in the art. Such water-soluble films may be based on plastics such as polyethylene glycols, polyacrylamides, polyacrylic acid copolymers, and polyvinyl alcohols and/or alternatively a soluble paper, which may be modified to fine tune the dissolution properties. Water-soluble films with different dissolution properties such as suitable water temperatures and/or dissolution times are available and can be selected according to the needs.

The benefit of using water-dissolvable packages is that the package containing the solid composition can be simply added to the water and it is not necessary to take the solid composition from the package before addition to the water.

In a particular preferred embodiment, the disclosure is directed to a unit dosage package, comprising a package, preferably a water-soluble package, and the solid composition of the disclosure packaged in the package. The package is preferably a sachet or a pod, preferably a water-soluble sachet or water-soluble pod.

Alternatively, the single-dose package may be in the form of a water-soluble sachet or pod having two separate compartments, such that a solid composition may also be provided separately from a liquid composition.

The solid composition of the disclosure and its suitable forms as well as suitable packages have been described above so that reference is made thereto.

The benefit of the unit dosage package of the disclosure is that the no dosing operations are required for the user. In the preferred embodiment, where the package of the unit dosage package is water-soluble, the user also does not need to take the composition from the package, but can simply put the unit dosage package directly into the water.

The content of the solid composition in the unit dosage package may vary according to the requirements. A unit dosage package of the disclosure may e.g. include 2 g to 40 g, preferably 5 g to 20 g, of the solid composition of the disclosure. Suitable sizes are e.g. unit dosage packages having a solid composition content of 15 g or 10 g.

### Use of the Solid Composition or Unit Dosage Package

The disclosure is also directed to the use of the solid composition of the disclosure or the unit dosage package of the disclosure as a cleaning agent and disinfectant, in particular for hard surfaces, wherein, before use, the solid composition is dissolved in water to obtain an aqueous solution.

The solid composition of the disclosure and its suitable forms as well as suitable packages and unit dosage packages have been described above so that reference is made thereto.

When the solid composition of the disclosure is packaged in a package or unit dosage package, which are water-soluble, the package or unit dosage package can be directly added to the water. If the package or unit dosage package is not water-soluble, the solid composition is to be taken from the package or unit dosage package, before addition into the water.

As mentioned above, the concentration of the solid composition in the water may vary in wide ranges. Suitable concentrations of the solid composition in the water or aqueous solution may be for instance 1 g to 90 g solid composition per litre water, preferably 5 g to 20 g of solid composition per litre water, and more preferably 8 g to 10 g solid composition per litre water.

The use of the solid composition according to the disclosure is suitable for cleaning and disinfecting any surfaces, but it is preferred that the surface is a hard surface. Examples of hard surfaces are surfaces of walls, floors, tiles, fittings, sink basins, toilets, rails, devices or soft furnishings such as hospital mattresses and chairs. An example of a device is an automated machine. It is also possible to include the aqueous solution including the dissolved solid composition into a device such as an automated machine in order to clean and disinfect inner surfaces of the device.

According to a preferred embodiment, the use of the solid composition according to the disclosure is use as a floor cleaning agent and disinfectant.

The use according to the disclosure is suitable for any location, such as industrial settings, and is particularly suitable for healthcare facilities, domestic facilities, agriculture facilities, public facilities or facilities in the veterinary or food sector. Examples of public facilities are schools, gyms and offices.

A particular preferred use of the solid composition according to the disclosure is for healthcare cleaning and disinfection.

The instant disclosure is further illustrated in the following non-limiting examples.

### EXAMPLES

### Example 1

A preferred solid composition according to the present disclosure was prepared in the form of granules with the formulations shown in the following tables. Sodium percarbonate (SP) is the peroxygen donor. TAED (tetraacetylethylenediamine) is the acetyl donor. The chelating agent is 1-hydroxyethylidene-1,1-diphosphonic acid (HEDP). The surfactant is sodium lauryl sulfate (SLS).

The coated citric acid used is a granular powder composed of about 80% by weight of citric acid and about 20% by weight of coating. The coating is made of palm oil. The coated citric acid is a granular powder having a granule size of less than 2000 micron, i.e. at least 99% by weight of a sample pass through a 2000 micron sieve. The coated citric acid used is a commercial product, for example CR300 Citric acid 80% T3495 from TasteTech Ltd., England and Wales.

Tables 1 and 2 set out two embodiments of the composition. Each version has efficacy. In our tests, as set out below, Formulation B is the most effective formulation. Formulation A has other advantages, and is an advancement over the prior art.

### Formulation A

TABLE 1

| Ingredient | % by weight | Weight in grams |
|---|---|---|
| Sodium Percarbonate | 56.88 | 8.53 |
| TAED | 28.44 | 4.27 |
| 20% Coated Citric Acid | 10.00 | 1.50 |
| HEDP | 0.80 | 0.12 |
| Glycolic acid | 0.50 | 0.08 |
| SLS | 3.38 | 0.51 |

Examples 2 to 8 are based on tests carried out on Formulation A. Where there have been minor departures from this formulation exact formulations for each example are set out below.

### Formulation B

TABLE 2

| Ingredient | % by weight |
|---|---|
| Sodium Percarbonate | 47.36 |
| TAED | 23.71 |
| 20% Coated Citric Acid | 25.00 |
| HEDP | 0.67 |
| Glycolic acid | 0.44 |
| SLS | 2.82 |

For corresponding test results, refer to Example 12 and the comparative test data. The solid compositions can be packaged in sachets or pods, preferably water-soluble sachets or pods, e.g. in form of unit dosage packages.

### Examples 2 to 12

Many formulations and combination of ingredients have been analysed in order to study various parameters of the solid composition.

After addition, the PAA generation in the aqueous solution was determined over the time by means of a spectrophotometer. The active PAA was calculated from the total PAA taking into account the pH.

### Example 2—Powder Vs. Granule Peroxygen Donor

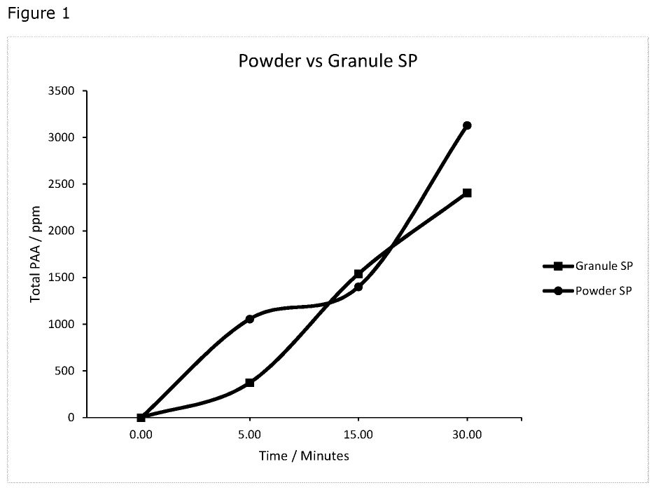

Different formulations were prepared, wherein in one sample a granule sodium percarbonate was used, and in the other sample a sodium percarbonate in form of a powder was used. The results of PAA generation are shown in FIG. 1. The exact formulation used in example 2 is detailed in table 3 below. The sample was of a mass of 23.89 g and given in 1000 ml of cold water at a temperature of 15 to 20° C. Citric acid was omitted from this example.

TABLE 3

| Ingredient | % by weight | Weight in grams |
|---|---|---|
| Sodium Percarbonate | 62.79 | 15.00 |
| TAED | 31.39 | 7.50 |
| 20% Coated Citric Acid | 0.00 | 0.00 |
| HEDP | 1.00 | 0.24 |
| Glycolic acid | 0.63 | 0.15 |
| SLS | 4.19 | 1.00 |

The results show that the use of sodium percarbonate (SP) in powder form does not have a big impact on PAA generation.

### Example 3—Amount of Coated Citric Acid

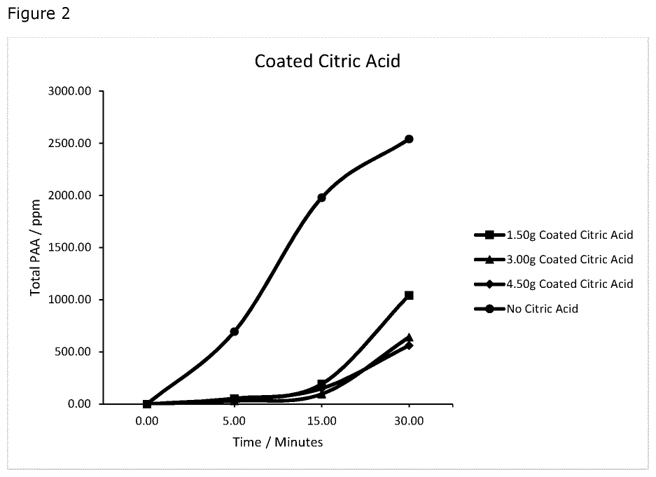

Formulation 3.1 was prepared (1.5 g coated citric acid) and the mass of the sample was 25.39 g and given in 1000 ml of cold water at a temperature of 15 to 20° C. Modified formulations, formulation 3.2 (sample mass: 26.89) and formulation 3.3 (sample mass: 28.39), with higher amounts of coated citric acid were prepared (3 g coated citric acid (11% by weight) and 4.5 g (16% by weight) and without coated citric acid were prepared. The results of PAA generation are shown in FIG. 2. The exact formulation used in example 3 is detailed in table 4 below.

The formulation without citric acid corresponds to the formulation shown in table 3. The additional components of the other are as detailed in FIG. 2.

TABLE 4

| Ingredient | % by weight | Weight in grams |
|---|---|---|
| Formulation 3.1 | | |
| Sodium Percarbonate | 59.08 | 15.00 |
| TAED | 29.54 | 7.50 |
| 20% Coated Citric Acid | 5.91 | 1.50 |
| HEDP | 0.95 | 0.24 |
| Glycolic acid | 0.59 | 0.15 |
| SLS | 3.94 | 1.00 |
| Formulation 3.2 | | |
| Sodium Percarbonate | 55.78 | 15.00 |
| TAED | 27.89 | 7.50 |
| 20% Coated Citric Acid | 11.16 | 3.00 |
| HEDP | 0.89 | 0.24 |
| Glycolic acid | 0.56 | 0.15 |
| SLS | 3.72 | 1.00 |
| Formulation 3.3 | | |
| Sodium Percarbonate | 52.84 | 15.00 |
| TAED | 26.42 | 7.50 |
| 20% Coated Citric Acid | 15.85 | 4.50 |
| HEDP | 0.85 | 0.24 |
| Glycolic acid | 0.53 | 0.15 |
| SLS | 3.52 | 1.00 |

The results show that the total PAA is always higher when no acid buffer is included, which is due to the reaction mechanism. The total PAA is lower when citric acid is included. However, the active PAA is much higher when the formulation includes citric acid. As active PAA is thought to be the efficacious species. This will ensure effective kill of organisms with suitable contact times.

### Example 4—Amount of Glycolic Acid

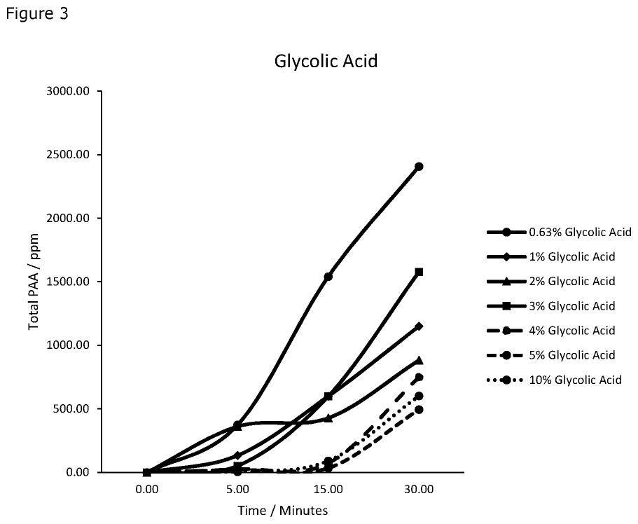

Formulation 4.1 (sample mass: 23.89 g) was prepared (0.63% glycol acid) and compared with modified formulations Formulation 4.2 (sample mass: 24.04 g), Formulation 4.3 (sample mass: 24.34 g), Formulation 4.4 (sample mass: 24.64 g), Formulation 4.5 (sample mass: 24.94 g), Formulation 4.6 (sample mass: 25.24 g), and Formulation 4.7 (sample mass: 26.74 g)) with higher amounts of glycolic acid (1.25%, 2.47%, 3.65%, 4.81%, 5.94%, 11.22%). All formulations were prepared by adding the solid composition in 1000 ml of cold water at a temperature of 15 to 20° C. The results of PAA generation are shown in FIG. 3.

The exact formulation used in example 4 is detailed in table 5 below.

TABLE 5

| Ingredient | % by weight | Weight in grams |
|---|---|---|
| Formulation 4.2 | | |
| Sodium Percarbonate | 62.40 | 15.00 |
| TAED | 31.20 | 7.50 |
| 20% Coated Citric Acid | 0.00 | 0.00 |
| HEDP | 1.00 | 0.24 |
| Glycolic acid | 1.25 | 0.30 |
| SLS | 4.16 | 1.00 |
| Formulation 4.3 | | |
| Sodium Percarbonate | 61.63 | 15.00 |
| TAED | 30.81 | 7.50 |
| 20% Coated Citric Acid | 0.00 | 0.00 |
| HEDP | 0.99 | 0.24 |
| Glycolic acid | 2.47 | 0.60 |
| SLS | 4.11 | 1.00 |
| Formulation 4.4 | | |
| Sodium Percarbonate | 60.88 | 15.00 |
| TAED | 30.44 | 7.50 |
| 20% Coated Citric Acid | 0.00 | 0.00 |
| HEDP | 0.97 | 0.24 |
| Glycolic acid | 3.65 | 0.90 |
| SLS | 4.06 | 1.00 |
| Formulation 4.5 | | |
| Sodium Percarbonate | 60.14 | 15.00 |
| TAED | 30.07 | 7.50 |
| 20% Coated Citric Acid | 0.00 | 0.00 |
| HEDP | 0.96 | 0.24 |
| Glycolic acid | 4.81 | 1.20 |
| SLS | 4.01 | 1.00 |
| Formulation 4.6 | | |
| Sodium Percarbonate | 59.43 | 15.00 |
| TAED | 29.71 | 7.50 |
| 20% Coated Citric Acid | 0.00 | 0.00 |
| HEDP | 0.95 | 0.24 |
| Glycolic acid | 5.94 | 1.50 |
| SLS | 3.96 | 1.00 |
| Formulation 4.7 | | |
| Sodium Percarbonate | 56.10 | 15.00 |
| TAED | 28.05 | 7.50 |
| 20% Coated Citric Acid | 0.00 | 0.00 |
| HEDP | 0.90 | 0.24 |
| Glycolic acid | 11.22 | 3.00 |
| SLS | 3.74 | 1.00 |

Formulation 4.1 is the same as that shown in table 3. For the modified formulations glycolic acid is added as per the percentages indicated.

The results show that the 0.63% glycolic acid generated the highest total PAA concentration at 15 min and 30 min.

### Example 5—Various Coated Organic Acids

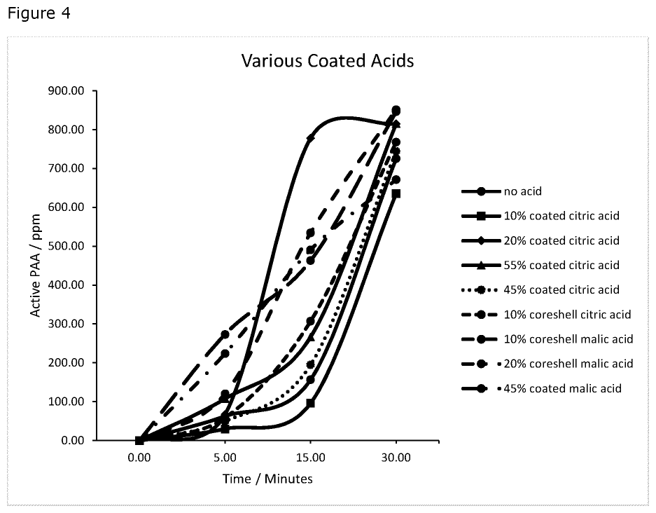

Different formulations based on Formulation 5.1 were prepared with various coated organic acids with respect to the type of the organic acid (10%, 20%, 40%, or 55% citric acid or 45% malic acid) and different amounts of coating are used. Core-shell organic acids such as 10% or 20% core-shell malic acid or 10% core-shell citric acid are also used as coated organic acids. The results of PAA generation are shown in FIG. 4. The exact composition of formulation 5.1 used in example 5 is detailed in table 6 below. The samples had a mass of 26.89 g and were given in 1000 ml of cold water at a temperature of 15 to 20° C.

TABLE 6

| Ingredient | % by weight | Weight in grams |
|---|---|---|
| Sodium Percarbonate | 55.78 | 15.00 |
| TAED | 27.89 | 7.50 |
| organic acid | 11.16 | 3.00 |
| HEDP | 0.89 | 0.24 |
| Glycolic acid | 0.56 | 0.15 |
| SLS | 3.72 | 1.00 |

For the formulation with no acid, the formulation is the same as that set out in table 3. For each of the other samples shown in FIG. 4 the identity of the coated acid, and the details relating to the added coated acid, are set out.

The results show that 20% coated citric acid generates the highest PAA within 15 minutes. This demonstrates that the use of coated citric acid allows the pH to be maintained, which in turn supports the continued and sustained formation of PAA.

### Example 6-Various Coated Organic Acids and Addition of a Base

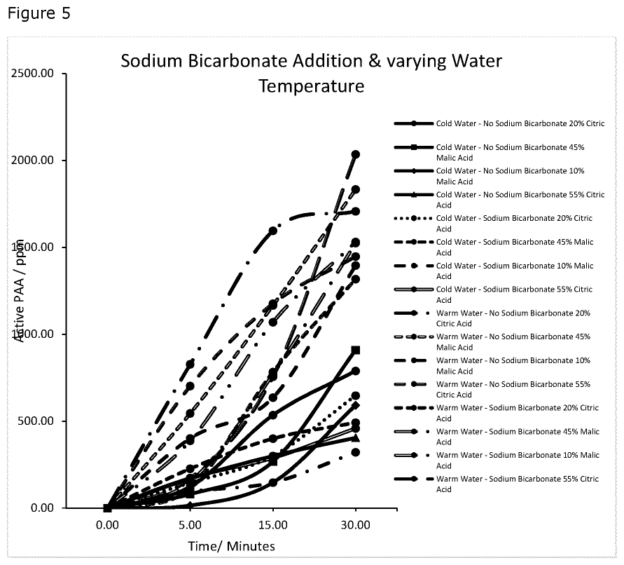

Different formulations based on formulation 6.1 were prepared with various coated organic acids with respect to the type of organic acid (citric acid or malic acid) and different amounts of coatings were used. In some examples, a base (sodium bicarbonate) was also added. Moreover, the samples were tested with 1000 ml of cold water having a temperature of about 15 to 20° C. and 1000 ml of warm water having a temperature of 35 to 40° C. The results of PAA generation are shown in FIG. 5.

Table 7 shows the formulation used for the sample with 20% coated citric acid. The samples had a mass of 26.90 g.

TABLE 7

| Ingredient | % by weight | Weight in grams |
|---|---|---|
| Sodium Percarbonate | 55.76 | 15.00 |
| TAED | 27.88 | 7.50 |
| 20% Coated Citric Acid | 11.15 | 3.00 |
| HEDP | 0.93 | 0.25 |
| Glycolic acid | 0.56 | 0.15 |
| SLS | 3.72 | 1.00 |

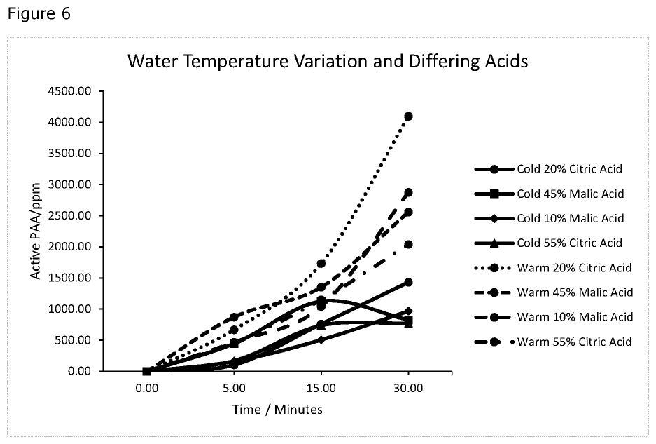

The remaining samples were prepared based on formulation 6.1, but the 20% coated citric acid was replaced as shown in FIG. 5. Additionally, the samples that are labelled as comprising sodium bicarbonate in FIG. 6 are based on formulation 6.1. 2 g of sodium bicarbonate has been added to these samples marked as comprising sodium bicarbonate, additionally the amount of acid was increased from 3.0 g to 6.0 g. The samples had a mass of 31.90 g.

TABLE 8

| Ingredient | % by weight | Weight in grams |
|---|---|---|
| Sodium Percarbonate | 47.02 | 15.00 |
| TAED | 23.51 | 7.50 |
| coated organic acid | 18.81 | 6.00 |
| HEDP | 0.78 | 0.25 |
| Glycolic acid | 0.47 | 0.15 |
| SLS | 3.13 | 1.00 |
| Sodium Bicarbonate | 6.27 | 2.00 |

Sodium bicarbonate was added to increase the pH to aid in PAA generation and then various coated acids were included to reduce the pH. 20% coated citric acid without sodium bicarbonate produced the highest active PAA concentration after 15 minutes.

### Example 7—Various Coated Organic Acids and Addition to Cold and Warm Water

Different formulations were prepared with various coated organic acids with respect to type of organic acid (citric acid or malic acid) and different amounts of coating. Moreover, the samples were tested with 500 ml of cold water having a temperature of about 15 to 20° C. and 500 ml of warm water having a temperature of 35 to 40° C. The results of PAA generation are shown in FIG. 6.

The formulation used in the sample identified as comprising 20% coated citric acid is shown in table 9 below. The remaining samples in this example are the same, except that the 20% coated citric acid has been replaced for the samples listed with alternative coated organic acids/alternative amounts of coatings. The samples had a mass of 14.95 g.

TABLE 9

| Ingredient | % by weight | Weight in grams |
|---|---|---|
| Sodium Percarbonate | 56.88 | 8.50 |
| TAED | 28.44 | 4.25 |
| coated organic acid | 10.04 | 1.50 |
| HEDP | 0.80 | 0.12 |
| Glycolic acid | 0.50 | 0.08 |
| SLS | 3.35 | 0.50 |

The results show that using 20% coated citric acid in warm water generates the most PAA after 15 & 30 minutes. This is advantageous for the efficacy of the product.

### Example 8—Various Amounts of Solid Composition and Addition into Cold and Warm Water

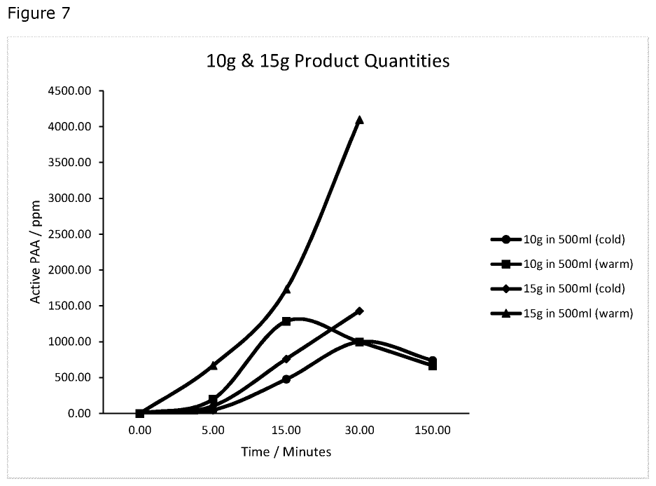

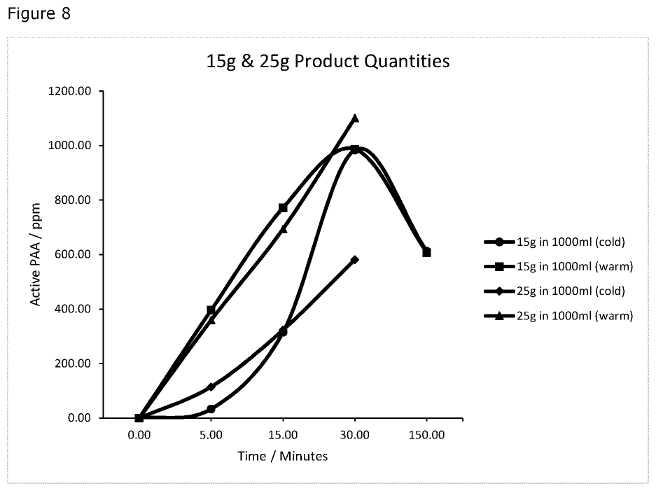

Different formulations were prepared as the solid composition. Different amounts of the solid composition added into water were tested (10 g and 15 g in 500 ml of water, and 15 g and 25 g in 1000 ml of water). Moreover, the samples were tested with cold water having a temperature of about 15 to 20° C. and warm water having a temperature of 35 to 40° C. The results of PAA generation are shown in FIGS. 7 and 8.

Table 10 provides the formulation used for the 10 g sample. Table 11 provides the formulation used in the 15 g sample.

TABLE 10

| Ingredient | % by weight | Weight in grams |
|---|---|---|
| Sodium Percarbonate | 56.88 | 5.69 |
| TAED | 28.44 | 2.84 |
| 20% Coated Citric Acid | 10.03 | 1.00 |
| HEDP | 0.80 | 0.08 |
| Glycolic acid | 0.50 | 0.05 |
| SLS | 3.35 | 0.34 |

TABLE 11

| Ingredient | % by weight | Weight in grams |
|---|---|---|
| Sodium Percarbonate | 56.88 | 8.53 |
| TAED | 28.44 | 4.27 |
| 20% Coated Citric Acid | 10.03 | 1.50 |
| HEDP | 0.80 | 0.12 |
| Glycolic acid | 0.50 | 0.08 |
| SLS | 3.35 | 0.50 |

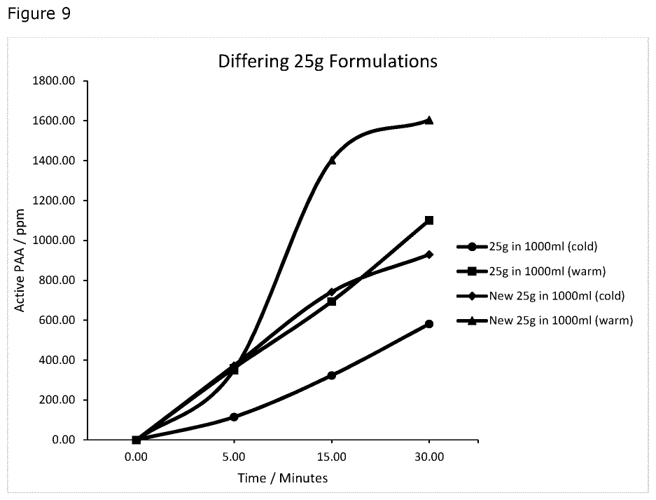

Moreover, the samples with 25 g in a sachet assessed in cold water (room temp.) vs warm water in 1000 ml were compared with a modified solid composition where the coated citric acid content was increased by 2% in a sachet. This modified solid composition is labelled as “new”. The results of PAA generation of this comparison are shown in FIG. 9.

The original 25 g composition is shown in Table 12. The “new” formulation is shown in table 13.

TABLE 12

| Ingredient | % by weight | Weight in grams |
|---|---|---|
| Sodium Percarbonate | 57.38 | 14.00 |
| TAED | 28.69 | 7.00 |
| 20% Coated Citric Acid | 8.20 | 2.00 |
| HEDP | 1.02 | 0.25 |
| Glycolic acid | 0.61 | 0.15 |
| SLS | 4.10 | 1.00 |

TABLE 13

| Ingredient | % by weight | Weight in grams |
|---|---|---|
| Sodium Percarbonate | 56.88 | 14.22 |
| TAED | 28.44 | 7.11 |
| 20% Coated Citric Acid | 10.03 | 2.51 |
| HEDP | 0.80 | 0.20 |
| Glycolic acid | 0.50 | 0.13 |
| SLS | 3.35 | 0.84 |

These data show that the formation of Active PAA increases with increasing content of coated citric acid.

### Example 9-Various Amounts of 20% Coated Citric Acids

Different formulations were prepared wherein the amount of 20% coated citric acid was varied (6% for Formulation 9.1, 10% for Formulation 9.2, 12% for Formulation 9.3). The exact composition of formulation 9.1, Formulation 9.2 and Formulation 9.3 used in example 9 is detailed in table 14 below. The samples had a mass of 15.00 g.

TABLE 14

| Ingredient | % by weight | Weight in grams |
|---|---|---|
| Formulation 9.1 | | |
| Sodium Percarbonate | 59.56 | 8.93 |
| TAED | 29.78 | 4.47 |
| 20% Coated Citric Acid | 6.01 | 0.90 |
| HEDP | 0.80 | 0.12 |
| Glycolic acid | 0.50 | 0.08 |
| SLS | 3.35 | 0.50 |
| Formulation 9.2 | | |
| Sodium Percarbonate | 56.88 | 8.53 |
| TAED | 28.44 | 4.27 |
| 20% Coated Citric Acid | 10.00 | 1.50 |
| HEDP | 0.80 | 0.12 |
| Glycolic acid | 0.50 | 0.08 |
| SLS | 3.38 | 0.51 |
| Formulation 9.3 | | |
| Sodium Percarbonate | 55.55 | 8.33 |
| TAED | 27.78 | 4.17 |
| 20% Coated Citric Acid | 12.02 | 1.80 |
| HEDP | 0.80 | 0.12 |
| Glycolic acid | 0.50 | 0.08 |
| SLS | 3.35 | 0.50 |

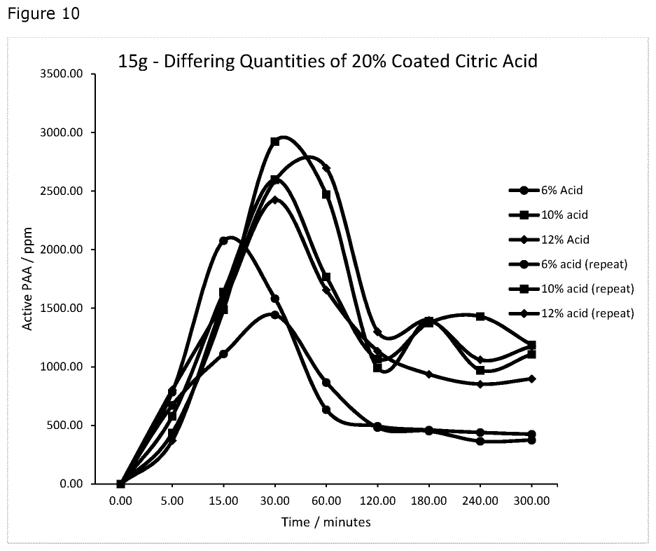

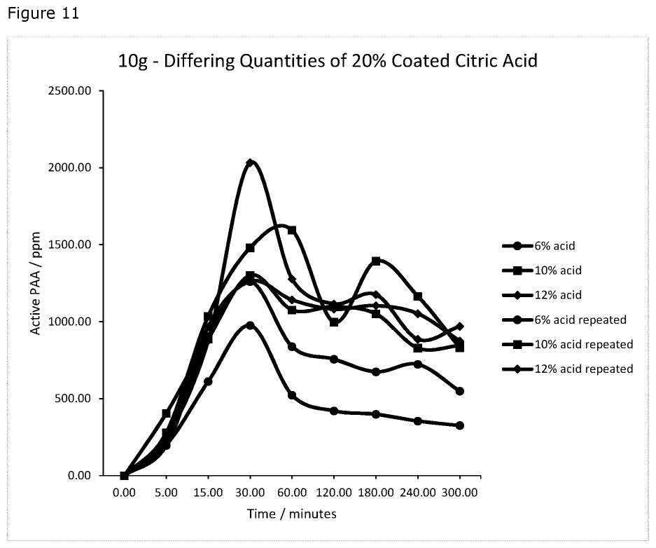

In one trial 15 g of the solid composition was added to 500 ml of water (as shown in FIG. 10). In a further trial 10 g of the solid composition was added to 500 ml of water (as shown in FIG. 11). The results of PAA generation are shown in FIGS. 10 and 11.

The measurement of Formulation 9.2 and Formulation 9.3 were repeated several times to check the variation within the repetitions.

Repeats of the experiments were carried out for each variation. These tests show that Formulation 9.1 is not as advantageous, as the amount of active PAA generated is lower than for Formulation 9.2 and Formulation 9.3. 10% coated citric acid was selected and the following data is based on this inclusion level.

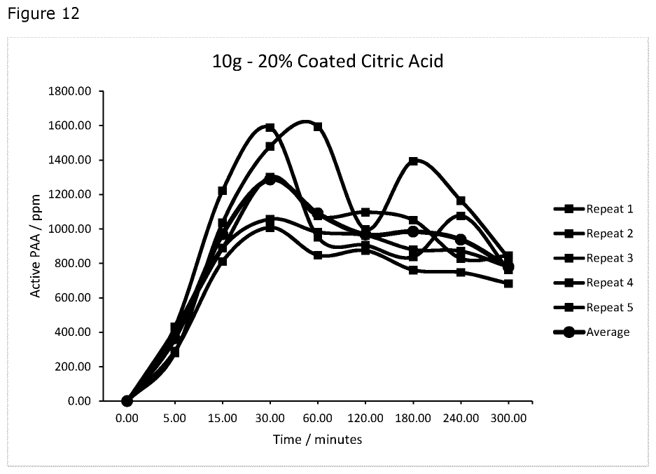

The results of PAA generation for the use of 10 g of the solid composition are shown in FIG. 12.

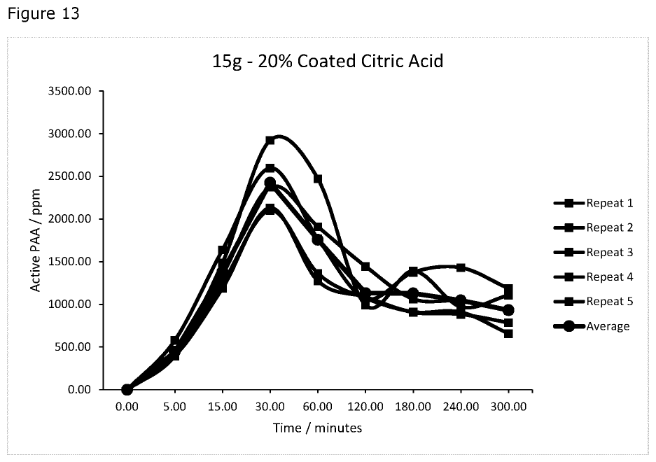

The results of PAA generation for the use of 15 g of the solid composition are shown in FIG. 13.

### Example 10—Ratio of Peroxygen Donor to Acetyl Donor

Different ratios of peroxygen donor (SP): acetyl donor (TAED) were analysed and a ratio of 2:1 SP: TAED was found to result in the highest generation of PAA. The solid compositions were added to 1000 ml of cold water at a temperature of 15 to 20° C.

### Example 11—Amount of Chelating Agent

Varying levels of chelating agent (HEDP) were used to assess their impact on PAA generation. Higher HEDP inclusions caused a reduction in PAA. The solid compositions were added to 1000 ml of cold water at a temperature of 15 to 20° C.

### Example 12—Amount of Coated Citric Acid and Long Term Test

Different formulations were prepared with increased weight amounts of coated citric acid (12.9% for Formulation 12.1, 16% for Formulation 12.2, 20.6% for Formulation 12.3 and 25% for Formulation 12.4). The exact composition of formulation 12.1, Formulation 12.2, Formulation 12.3 and Formulation 12.4 used in example 12 is detailed in table 15 below. The samples had a mass of 15.51 g, 16.01 g, 17.01 g and 18.01 g, respectively.

TABLE 15

| Ingredient | % by weight | Weight in grams |
|---|---|---|
| Formulation 12.1 | | |
| Sodium Percarbonate | 55.00 | 8.53 |
| TAED | 27.53 | 4.27 |
| 20% Coated Citric Acid | 12.89 | 2.00 |
| HEDP | 0.77 | 0.12 |
| Glycolic acid | 0.52 | 0.08 |
| SLS | 3.29 | 0.51 |
| Formulation 12.2 | | |
| Sodium Percarbonate | 53.28 | 8.53 |
| TAED | 26.67 | 4.27 |
| 20% Coated Citric Acid | 15.62 | 2.50 |
| HEDP | 0.75 | 0.12 |
| Glycolic acid | 0.50 | 0.08 |
| SLS | 3.19 | 0.51 |
| Formulation 12.3 | | |
| Sodium Percarbonate | 50.15 | 8.53 |
| TAED | 25.10 | 4.27 |
| 20% Coated Citric Acid | 20.58 | 3.50 |
| HEDP | 0.71 | 0.12 |
| Glycolic acid | 0.47 | 0.08 |
| SLS | 3.00 | 0.51 |
| Formulation 12.4 | | |
| Sodium Percarbonate | 47.36 | 8.53 |
| TAED | 23.71 | 4.27 |
| 20% Coated Citric Acid | 24.99 | 4.50 |
| HEDP | 0.67 | 0.12 |
| Glycolic acid | 0.44 | 0.08 |
| SLS | 2.83 | 0.51 |

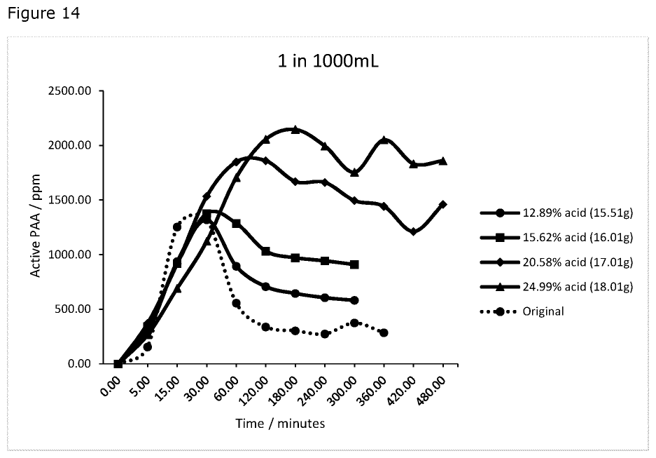

The formulations were prepared as a unit dosage package in a sachet with a content of 15 to 18 g solid composition depending on the coating percentage. The solid compositions taken from the sachet were added into 1000 mL of warm water (35 to 40° C.) with no stirring. The PAA generation was studied until 480 min after addition. The results are shown in FIG. 14.

The results show that the formulations with a content of 20.6% and 25% by weight coated citric acid produce a relatively constant and high PAA concentration over a long period.

Unit dosage packages of the Formulation 12.4 with a content of 9 g and 18 g of the solid composition were prepared. The formulations are given in the following table.

TABLE 16

| | | 9 g sample | 18 g sample |
|---|---|---|---|
| Ingredient | % w/w | g | g |
| Sodium Percarbonate | 47.36 | 4.26 | 8.52 |
| TAED | 23.71 | 2.13 | 4.27 |
| 20% Coated Citric Acid | 25.00 | 2.25 | 4.50 |
| HEDP | 0.67 | 0.06 | 0.12 |
| Glycolic acid | 0.44 | 0.04 | 0.08 |
| SLS | 2.82 | 0.25 | 0.51 |

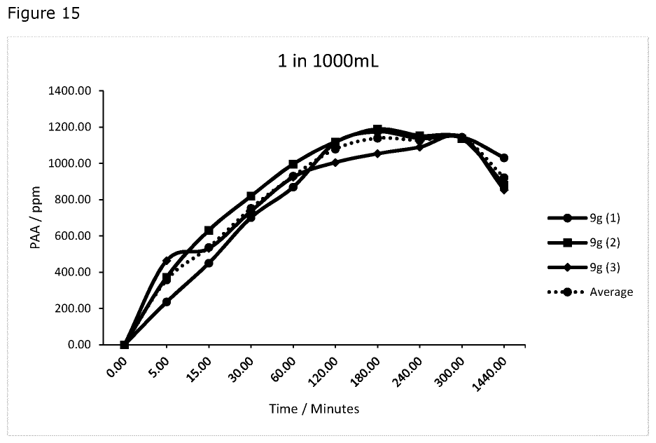

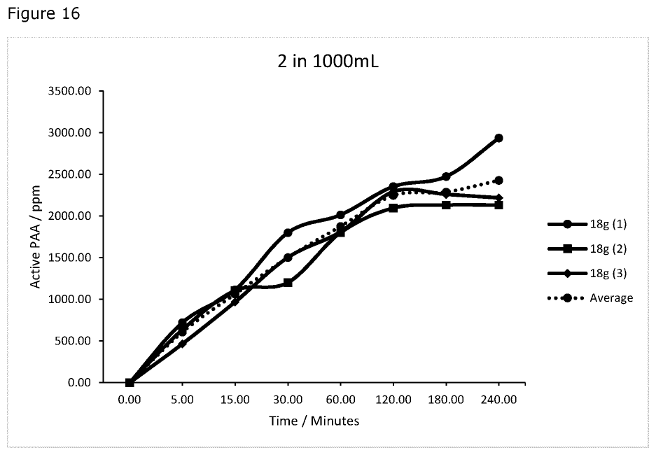

Each of the 9 g sample and the 18 g sample in triplicate were added into 1000 ml of warm water (35 to 40° C.) with no stirring. The PAA generation was studied until 1440 min and 240 min, respectively, after addition. The results are shown in FIGS. 15 and 16.

The results show that both a low concentration and a high concentration of the solid composition in water produce a rather constant and high PAA concentration over a long period.

### Comparative Test Data

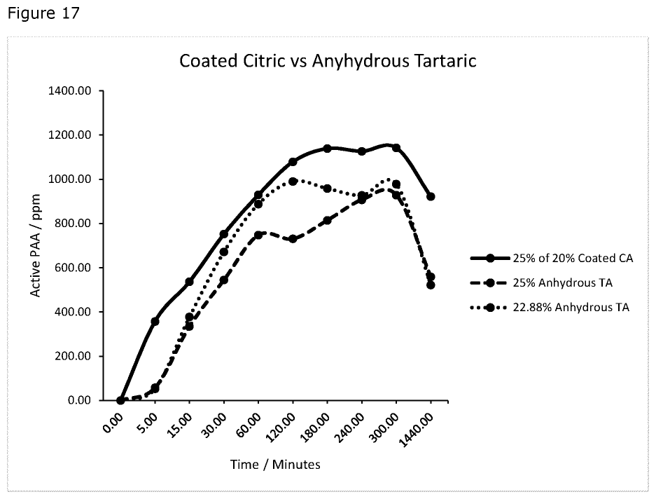

Comparative tests were carried out to determine the influence of the coating of the organic acid compared to a non-coated organic acid. Different formulations were prepared, varying the amount of anhydrous tartaric acid, 22.88% for Formulation 1 with a sample mass of 8.74 g and 25.00% for Formulation 2 with a sample mass of 9.00 g. This was then compared to the coated citric acid formulation, 25% for Formulation 3 with a sample mass of 9.00 g. All formulations were prepared by adding the solid composition in 1000 ml of warm water at a temperature of 35 to 40° C. This is shown in FIG. 17. The formulations are given in the following table.

TABLE 17

| Ingredient | % by weight | Weight in grams |
|---|---|---|
| Formulation 1 | | |
| Sodium Percarbonate | 48.74 | 4.26 |
| TAED | 24.37 | 2.13 |
| Tartaric Acid | 22.88 | 2.00 |
| HEDP | 0.69 | 0.06 |
| Glycolic acid | 0.46 | 0.04 |
| SLS | 2.86 | 0.25 |
| Formulation 2 | | |
| Sodium Percarbonate | 47.36 | 4.26 |
| TAED | 23.71 | 2.13 |
| Tartaric Acid | 25.00 | 2.25 |
| HEDP | 0.67 | 0.06 |
| Glycolic acid | 0.44 | 0.04 |
| SLS | 2.82 | 0.25 |
| Formulation 3 | | |
| Sodium Percarbonate | 47.36 | 4.26 |
| TAED | 23.71 | 2.13 |
| 20% Coated Citric Acid | 25.00 | 2.25 |
| HEDP | 0.67 | 0.06 |
| Glycolic acid | 0.44 | 0.04 |
| SLS | 2.82 | 0.25 |

The results show that formulation 3 produce more active PAA after 15 minutes and continually throughout the experiment, especially after 24 hours.

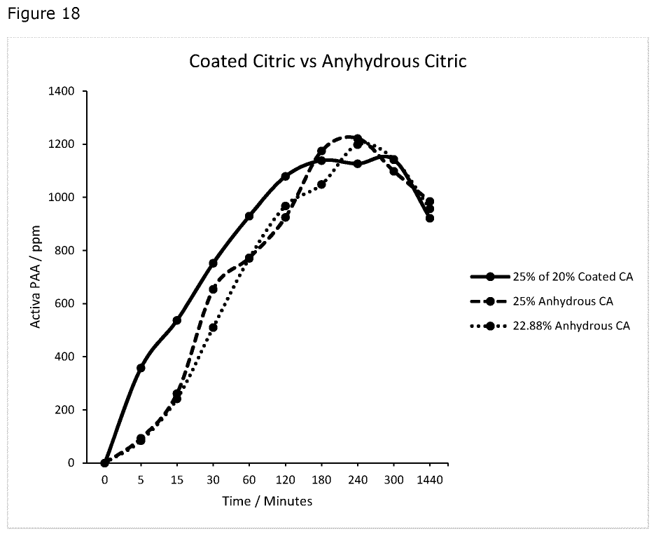

Different Formulations were prepared, varying the amount of anhydrous citric acid, 22.88% for Formulation 4 with a sample mass of 8.74 g and 25.00% for Formulation 5 with a sample mass of 9.00 g. This was then compared to the coated citric acid formulation. This is shown in FIG. 18. All formulations were prepared by adding the solid composition in 1000 ml of warm water at a temperature of 35 to 40° C. The formulations are given in the following table.

TABLE 18

| Ingredient | % by weight | Weight in grams |
|---|---|---|
| Formulation 4 | | |
| Sodium Percarbonate | 48.74 | 4.26 |
| TAED | 24.37 | 2.13 |
| Anhydrous Citric Acid | 22.88 | 2.00 |
| HEDP | 0.69 | 0.06 |
| Glycolic acid | 0.46 | 0.04 |
| SLS | 2.86 | 0.25 |
| Formulation 5 | | |
| Sodium Percarbonate | 47.36 | 4.26 |
| TAED | 23.71 | 2.13 |
| Anhydrous Citric Acid | 25.00 | 2.25 |
| HEDP | 0.67 | 0.06 |
| Glycolic acid | 0.44 | 0.04 |
| SLS | 2.82 | 0.25 |

The results show that formulation 3 produce substantially more active PAA after 15 minutes and continually throughout the experiment until 180 minutes (hour 3).

This also shows that anhydrous citric acid is not as advantageous as coated citric acid as the level of PAA generation during an initial time interval of 15 minutes is lower.

1. A solid composition, comprising
40 to 60% by weight of a peroxygen donor;
20 to 35% by weight of an acetyl donor;
10 to 35% by weight, of a coated organic acid; and
optionally 0.1 to 1.5% by weight of glycolic acid or lactic acid.

2. The solid composition according to claim 1, wherein the peroxygen donor is selected from the group consisting of sodium perborate, sodium percarbonate, sodium perphosphate, urea peroxide, peresters, superoxides, dioxygenyl, ozones, hydrogen peroxide, lithium peroxide, barium peroxide, di-tert-butyl peroxide, ammonium peroxydisulphate, potassium peroxymonosulphate, and any mixture thereof.

3. The solid composition according to claim 1, wherein the acetyl donor is selected from the group consisting of tetraacetylethylenediamine (TAED), methyl cellulose encapsulated TAED, acetyl salicylic acid, diacetyl dioxohexahydratriazine (DADHT), tetraacetyl glycoluril, acetyl urea, di-acetyl urea, tri-acetyl urea, pentaacetyl glucose (PAG), tetraacetyl glycoluril (TAGU), acetyl phosphate, acetyl imidazole, acetyl COA, acetic anhydride, compounds containing a hemiacetal group, acetic acid, di-acetylmorphine, pyruvate, acetyl chloride, acetyl-caprolactam, N′N′-diacetyl-N′N′-dimethyl urea, and any mixture thereof.

4. The solid composition according to claim 1, wherein the coating of the coated organic acid is selected from the group consisting of oils, fats, and mixtures thereof.

5. The solid composition according to claim 1, further comprising 0.2 to 2% by weight of one or more chelating agents that include 1-hydroxyethylidene-1,1-diphosphonic acid (HEDP), and/or 0.5 to 8% by weight of one or more surfactants.

6. The solid composition according to claim 1, further comprising a further organic acid.

7. The solid composition of claim 6, wherein the further organic acid is 2 to 10% by weight.

8. The solid composition of claim 6, wherein the combination of the coated organic acid and the further organic acid is 15 to 35% by weight.

9. The solid composition according to claim 1, wherein the content of the organic acid in the coated organic acid is 30 to 96% by weight based on the total weight of the coated organic acid.

10. The solid composition according to claim 1, wherein the coated organic acid is in granular form, wherein the granule size of the coated organic acid is less than 5000 microns, and wherein the granule size is a d₉₉ value determined by sieve analysis.

11. The solid composition according to claim 1, wherein the solid composition is in the form of powder, granules, a mixture of powder and/or granules, tablets or capsules, or packaged in a package.

12. A unit dosage package, comprising a package and a solid composition according to claim 1 packaged in the package.

13. A unit dosage package according to claim 12, wherein the package is a sachet or pod.

14. A method of cleaning and disinfecting a hard surface, comprising dissolving the solid composition according to claim 1 in water to obtain an aqueous solution and applying the aqueous solution to a hard surface.

15. The method according to claim 14, wherein the hard surface is selected from the group consisting of walls, floors, tiles, fittings, sink basins, toilets, rails, and devices or soft furnishings.

16. The method according to claim 15, wherein the aqueous solution is applied to floors.

17. The method according to claim 15, wherein the hard surface is in a healthcare facility, a domestic facility, an agriculture facility, a public facility, a veterinary facility, or a food sector facility.

18. The solid composition according to claim 1, wherein the solid composition has 40 to 55% by weight of the peroxygen donor, 20 to 28% by weight, of the acetyl donor, 20 to 30% by weight of the coated organic acid, and optionally 0.3 to 1% by weight of the glycolic acid or lactic acid.

19. The solid composition according to claim 1, wherein the acetyl donor is in powder form, and wherein the coated organic acid has an organic acid selected from the group consisting of citric acid, malic acid, and tartaric acid.

20. The solid composition according to claim 5, wherein the solid composition has 0.3 to 1.5% by weight of the one or more chelating agents and/or 1 to 5% by weight of the one or more surfactants.
